(19) United States
(12) Patent Application Publication
(10) Pub. No.: US 2020/0107546 A1
(43) Pub. Date: Apr. 9, 2020

(54) METHODS AND COMPOSITIONS FOR CONTROLLING UNDESIRED VEGETATION SUCH AS INVASIVE ANNUAL GRASSES

(71) Applicant: BAYER CROPSCIENCE LP, Research Triangle Park, NC (US)

(72) Inventors: David R. SPAK, Cary, NC (US); Harold QUICKE, Windsor, CO (US)

(21) Appl. No.: 16/155,178

(22) Filed: Oct. 9, 2018

(51) Int. Cl. A01N 43/50; A01N 43/68

(52) U.S. Cl. CPC A01N 43/50; A01N 43/68

(57) ABSTRACT

Methods and compositions for controlling undesired vegetation, such as invasive annual grasses.

### FIELD

The disclosure provides methods and compositions for controlling undesired vegetation such as invasive annual grasses.

### BACKGROUND

There is an ongoing need for methods of controlling undesired vegetation, such as annual invasive grasses.

Annual grass seed can remain viable in the soil and thatch layer for many years. Presently available herbicidal compositions and other products often do not provide sufficient residual control to adequately address the total number of viable seeds, known as the “seed bank”.

Herbicides are often necessary for controlling weeds and other undesired plant pests. However, there is an ongoing need for newer herbicidal compositions as herbicide tolerance poses an obstacle to effective weed control.

Furthermore, there is a need for more selective herbicidal compositions and methods for controlling annual grasses as many herbicidal compositions exhibit phytotoxicity, thereby damaging or killing not only the undesired target plants (e.g., weeds), but also the desirable plants or crops intended to be protected.

The present inventors have found that compositions described herein not only provide effective control for unwanted annual grasses, but also do so without harming desirable plants or crops.

### SUMMARY

The present invention provides for methods for controlling invasive annual grasses, wherein a composition comprising, as an active ingredient, a short-residual (i.e., having a median soil half life of no greater than 50 days) imidazolinone herbicide, such as imazamox, is applied to a desirable plant or crop or seed, plant part, or habitat thereof or to a site in which one or more undesired annual grasses (e.g. weeds) is/are growing, for example, to rangelands.

The present invention further provides for methods for controlling invasive annual grasses, wherein a composition comprising, as active ingredients, (i) a short-residual (i.e., having a median soil half-life of no greater than 50 days)imidazolinone herbicide, such as imazamox, and (ii) at least one additional herbicide is applied to a desirable plant or crop or seed, plant part, or habitat thereof or to a site in which one or more undesired annual grasses (e.g. weeds) is/are growing.

The present invention further provides for compositions comprising, as active ingredients, a short-residual (i.e., having a median soil half-life of no greater than 50 days) imidazolinone herbicide, such as imazamox, and a long-residual (i.e., having a median soil half-life of greater than 50 days) herbicide, such as cellulose biosynthesis inhibitors, e.g., indaziflam.

It has been found that compositions comprising both a short-residual imidazoline and a long-residual cellulose biosynthesis inhibitor can demonstrate superior properties of controlling undesired invasive annual grasses.

It has also been found that application of compositions comprising, for example, imazamox and, optionally, indaziflam do not cause significant survival or injury issues in the desirable plants or crops to be protected.

Further objects, features, and advantages of the invention will become apparent from the detailed description that follows.

### DETAILED DESCRIPTION

Applicants have now found that compositions comprising (i) a short-residual herbicide belonging to the class of acetohydroxyacid synthase inhibitors, such as imidazolinones and optionally (ii) a long-residual herbicide belonging to the class of cellulose biosynthesis inhibitors can control undesired weeds, such as invasive annual grasses, when applied to areas, e.g., rangeland, in which invasive annual grasses and other weeds grow, including direct application to desirable plants or crops or seeds, parts, or a habitat thereof. The compositions and method of the invention can include active or inactive ingredients. For example, other herbicides may optionally be used in combination with the short-residual acetohydroxyacid synthase inhibitor and the long-residual cellulose biosynthesis inhibitor.

Imazamox is an imidazolinone compound characterized as an acetolactate synthase (ALS) or acetohydroxyacid synthase (AHAS) inhibitor, belonging to Weed Science Society of America (“WSSA”) Mode of Action group 2 (see: wssa.net/wp-content/uploads/WSSA-Mechanism-of-Action.pdf).

As used herein, “short-residual” denotes an herbicide having a median soil half-life of no greater than 50 days, such as less than 40 days or less than 30 days.

As used herein, “long-residual” denotes an herbicide which is not a short-residual herbicide, having a median soil half-life of greater than 50 days, such as greater than 75 days or greater than 100 days or greater than 150 days.

Imidazolinones are one class of acetohydroxyacid synthase inhibitor herbicides. Imidazolinones can be either short-residual or long-residual.

Imazamox is a short-residual imidazolinone herbicide having a soil half-life of about 20-30 days. Additionally, imazamethabenz methyl is a short-residual imidazolinone herbicide having a soil half-life of about 25-36 days.

Imazapic is a long-residual imidazolinone herbicide having a soil-half life of approximately 120 days.

Table 1 sets forth the soil half-lives of various imidazolinone herbicides:

TABLE 1

| | Soil half-life reported in the | |
|---|---|---|
| | Weed Science Society of | |
| | America's Herbicide Handbook | Median soil half-life |
| Imazamethabenz | 25-36 days | 30 days |
| methyl | | |
| Imazamox | 20-30 days | 25 days |
| Imazapic | 120 days | 120 days |
| Imazapyr | 25-142 days | 83 days |
| Imazaquin | 60 days | 60 days |
| Imazethapyr | 60-90 days | 75 days |

Acetohydroxyacid synthase inhibitors affect acetohydroxyacid synthase, an enzyme involved with the biosynthesis of the branched-chain amino acids leucine, isoleucine, and valine. Animals do not synthesize these amino acids via this pathway, thus imidazolinone herbicides generally exhibit very little toxicity to animals, birds, fish, and insects. Acetohydroxyacid synthase inhibitors are potent herbicides. Plant death results from events occurring in response to ALS inhibition and low branched-chain amino acid production, however the actual sequence of phytotoxic processes is unclear.

The methods and composition of the invention can advantageously be used to treat invasive grasses, such as on land where animals graze. Annual grass seed banks possess long-term viability for years. It has been surprisingly found that imazamox can be used to control such invasive annual grasses, especially when used with a cellulose biosynthesis inhibitor, even though imazamox has a short soil half-life.

Additional acetohydroxyacid synthase inhibitors include further imidazolinone compounds such as imazamethabenz-methyl, imazapyr, imazapic, imazethapyr, and imazaquin, as well as compounds belonging to the classes of pyrimidinylthiobenzoates, sulfonylaminocarbonyl-triazolinones (e.g., propoxycarbazone-sodium), sulfonylureas (e.g., rimsulfuron), and triazolopyrimidines.

Commercially available herbicides incorporating imazamox as their active ingredient include, for example, Raptor® herbicide (provided by BASF), Beyond® herbicide (provided by BASF), Clearcast® herbicide (provided by SePRO Corporation), Vulture™ herbicide (provided by Albaugh LLC), Imazacast herbicide (provided by Albaugh LLC), Imox® herbicide (provided by Alligare LLC), Pestanal® (provided by Sigma-Aldrich International GmbH), Imazamox 120SL herbicide (provided by ADAMA), Postscript™ herbicide (provided by ADAMA), and Imazamox 700 WG herbicide (provided by Imtrade Australia).

Imazamox's International Union of Pure and Applied Chemistry (IUPAC) name is 2-[(RS)-4-isopropyl-4-methyl-5-oxo-2-imidazolin-2-yl]-5-methoxymethylnicotinic acid. Imazamox is written chemically as C₁₅H₁₉N₃O₄ and has the following structural formula:

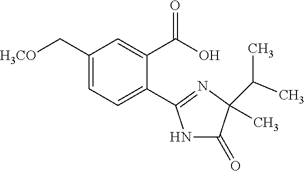 [SMILES: COCc1ccc(C2=NC(C)(C(C)C)C(=O)N2)c(C(=O)O)c1]

Imazamox has not previously been used for annual weed control in rangeland. In fact, no short-residual imidazolinones have been used in rangeland. Although imazamox is known to exhibit good post-emergence activity, imazamox has relatively short soil residual activity. Thus, imazamox has been regarded as a poor choice for control of annual grasses that have seeds that remain viable for many years in the soil.

Imazapic, a long-residual imidazolinone acetohydroxyacid synthase inhibitor herbicide, is presently used in rangeland areas and commonly used to control annual invasive grasses and weeds. Imazapic has a soil half-life of approximately 120 days as compared to imazamox's soil half-life of about 20-30 days.

Because imazamox and imazapic are both acetohydroxyacid synthase inhibitors (namely, imidazolinones) and thus have the same mode of action, it is not desirable to use imazamox in combination with imazapic. Although imazapic is regarded as effective, it would generally not be combined with a short-term acetohydroxyacid synthase inhibitor such as imazamox. Combining two or more herbicides having the same mode of action would potentially accelerate the development of resistance to herbicides having that mode of action.

Herbicidal compositions comprising imazamox are commonly used to control pests such as annual grasses and broadleaf weeds. Imazamox works well against, for example, common reed, flowering rush, invasive curly-leaf pondweed, cheatgrass, including all weeds listed on the labels of the commercial products.

Imazamox has been approved for use on residential and commercial property such as golf courses, lawns, walkways, cemeteries, evergreen nurseries, landscaping projects, and crop and vegetation management markets. By contrast, the present invention provides for methods and compositions useful for controlling annual invasive grasses in either natural areas or rangeland. It is surprising that such a short-residual herbicide would be useful in such applications.

As used herein, “natural area” denotes, for example, conservation lands set aside for preservation or restoration and used for recreation, ecosystem services, or other non-agricultural purposes, such as parks (e.g., city, county, state or national parks) and private woods.

As used herein, “rangeland” denotes any field or grassland area, especially areas used for grazing domestic livestock, protection of fauna and flora, restoration of fauna and flora or for recreation. Rangelands include, for example, tallgrass prairies, shortgrass prairies, desert grasslands, shrublands, woodlands, forests, savannas, chaparrals, and steppes. Rangelands are also called pampas.

As used herein, “natural areas” and “rangeland” are distinct sites.

The compositions of the invention can optinally include a cellulose biosynthesis inhibitor, such as indaziflam. Herbicidal compositions comprising indaziflam are commonly used to control pests such as annual grasses and broadleaf weeds. Indaziflam works well against, for example, crabgrass, goosegrass, kyllinga, bluegrass, doveweed, swinecress, bittercress and henbit, including all weeds listed on the labels of the commercial products.

In an aspect, a composition comprising a short-residual acetohydroxyacid synthase inhibitor, especially a short-residual imidazolinone, may be applied to a desirable plant or seed, part, or habitat thereof.

In another aspect, a composition comprising a short-residual acetohydroxyacid synthase inhibitor may be applied to a site in which no desirable plants are present or growing. For example, the composition can be applied directly to a monoculture of unwanted annual grass. Thereafter, new desirable plants might be planted and cultivated in the area.

In an aspect, a composition comprising a short-residual acetohydroxyacid synthase inhibitor is applied at a rate of 0.001 to 150 oz/A, or 0.01 to 100 oz/A, or 0.1 to 50 oz/A, or 0.5 to 25 oz/A (wherein “oz/A” denotes ounces per acre).

In an aspect, a composition comprising a cellulose biosynthesis inhibitor is applied at a rate of 0.001 to 150 oz/A, or 0.01 to 100 oz/A, or 0.1 to 50 oz/A, or 0.5 to 25 oz/A (wherein “oz/A” denotes ounces per acre).

A person having ordinary skill in the art would understand how to adjust dosages and concentrations depending on whether the composition is to be applied to a desirable plant or seed, part or habitat thereof, or directly to a site in which no desirable plants are present or growing (e.g., a monoculture of unwanted annual grass).

In an embodiment of the method of the present invention, a composition comprising a short-residual acetohydroxyacid synthase inhibitor and a cellulose biosynthesis inhibitor is applied to a desirable plant or seed, part, or habitat thereof.

In an embodiment of the method of the present invention, a composition comprising a short-residual acetohydroxyacid synthase inhibitor and a cellulose biosynthesis inhibitor is applied to a site in which no desirable plants are present or growing. For example, the composition can be applied directly to a monoculture of unwanted annual grass.

In an embodiment of the method of the present invention, a composition comprising a short-residual acetohydroxyacid synthase inhibitor is first applied to a desirable plant or seed, part, or habitat thereof, followed by application of a composition comprising a cellulose biosynthesis inhibitor

In an embodiment of the method of the present invention, a composition comprising a cellulose biosynthesis inhibitor is first applied to a desirable plant or seed, part, or habitat thereof, followed by application of a composition comprising a short-residual acetohydroxyacid synthase inhibitor.

In an embodiment of the method of the present invention, a composition comprising a short-residual acetohydroxyacid synthase inhibitor is first applied to a site in which no desirable plants are present or growing (e.g., a monoculture of unwanted annual grass), followed by application of a composition comprising a cellulose biosynthesis inhibitor

In an embodiment of the method of the present invention, a composition comprising a cellulose biosynthesis inhibitor is first applied to a site in which no desirable plants are present or growing (e.g., a monoculture of unwanted annual grass), followed by application of a composition comprising a short-residual acetohydroxyacid synthase inhibitor.

Compositions comprising indaziflam have been recognized as being suitable for generally controlling and inhibiting undesired vegetative growth of plants from seed without simultaneously killing the desirable crop plants.

The compound, indaziflam, which can be used in the present compositions and methods, is described in, for example, U.S. Pat. No. 8,114,991, which is hereby incorporated by reference in its entirety. The compound taught by U.S. Pat. No. 8,114,991 is described therein as having herbicidal properties. See U.S. Pat. No. 8,114,991 at, for example, column 62, line 22 to column 72, line 43. This patent teaches that indaziflam is a plant growth regulator, also known as a plant growth retardant.

Indaziflam's International Union of Pure and Applied Chemistry (IUPAC) name is N2-[(1R,2S)-2,3-dihydro-2,6-dimethyl-1H-inden-1-yl]-6-[(1RS)-1-fluoroethyl]-1,3,5-triazine-2,4-diamine Indaziflam is written chemically as C₁₆H₂₀FN₅. And has the following structural formula:

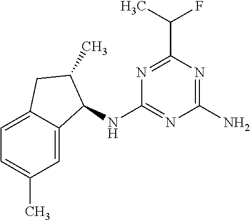 [SMILES: Cc1ccc2c(c1)[C@H](Nc1nc(N)nc(C(C)F)n1)[C@@H](C)C2]

Indaziflam is an alkylazine compound characterized as a cellulose biosynthesis inhibitor, belonging to Weed Science Society of America (“WSSA”) Mode of Action group 29 (see: wssa.net/wp-content/uploads/WSSA-Mechanism-of-Action.pdf).

Additional cellulose biosynthesis inhibitors include herbicides belonging to benzamide (WSSA group 21), nitrile (WSSA group 20), and triazolocarboxamides (WSSA group 28) classes of chemicals. For example, cellulose biosynthesis inhibitors of the benzamide family include isoxaben. Cellulose biosynthesis inhibitors of the nitrile family include dichlobenil and chlorthiamid. Cellulose biosynthesis inhibitors of the triazolocarboxamide family include flupoxam.

Cellulose biosynthesis inhibitor herbicides affect synthesis of the cellulose needed for cell walls in susceptible plants, thereby inhibiting cell division. These herbicides are absorbed through susceptible plants' roots and shoot tissues and inhibit root and shoot growth.

Commercially available herbicides incorporating indaziflam as their active ingredient include, for example, Alion®, Esplanade® F, Esplanade® EZ, Esplanade® 200 SC, Specticle® G, Specticle® FLO, Specticle® Total, Specticle® 20 WSP, Marengo®, and DuraZone®. Any commercially available herbicide comprising indaziflam as an active ingredient, and with appropriate labelling, may be used in the present invention.

Indaziflam is known to be useful as a pre-emergence or post-emergence herbicide for annual grasses and broadleaf weeds. Indaziflam has been approved for use on residential and commercial property such as golf courses, lawns, walkways, cemeteries, evergreen nurseries, landscaping projects, and crop and vegetation management markets.

Indaziflam must generally be applied and activated by rainfall before it will control germinating seedlings. A tank mix partner is needed to provide first-year control of germinating weeds if the application is after target weeds have already germinated or if insufficient precipitation to activate indaziflam is expected prior to weed germination. Suitable tank mix partners include glyphosate, imazapic, rimsulfuron, and propoxycarbozone.

Indaziflam is a long-residual herbicide, having a soil half-life of greater than 150 days (see Environmental Protection Agency Pesticide Fact Sheet for Indaziflam, page 25; www3.epa.gov/pesticides/chem_search/reg_actions/registration/fs_PC-080818_26-Jul-10.pdf)

The present inventors have found that a single application of indaziflam can prevent germination of annual grasses for multiple years. This provides land managers with a new opportunity to start the process of depleting the annual grass “seed bank.”

The present disclosure further provides for compositions for controlling invasive grasses. The present inventors have found that in a tank mix or pre-mix with a cellulose biosynthesis inhibitor such as indaziflam, a short-residual acetohydroxyacid synthase inhibitor may provide post-emergence control resulting in good control in, for example, the first year after treatment while the cellulose biosynthesis inhibitor then provides continued residual control.

In an aspect, compositions of the present invention comprise as active ingredients (“ai”) one or more cellulose biosynthesis inhibitors and one or more acetohydroxyacid synthase inhibitors.

In an embodiment, the cellulose biosynthesis inhibitor is a long-residual herbicide, preferably indaziflam.

In certain embodiments of compositions of the present invention, the acetohydroxyacid synthase inhibitor is an imidazolinone, preferably imazamox, imazamethabenz methyl, imazapic, imazapyr, imazaquin, or imazethapyr, and even more preferably imazamox.

In certain embodiments of compositions of the present invention, the acetohydroxyacid synthase inhibitor is short-residual, more preferably a short-residual imidazolinone, and even more preferably imazamox.

In an aspect, compositions described herein may optionally comprise one or more active ingredients in addition to one or more acetohydroxyacid synthase inhibitors and one or more cellulose biosynthesis inhibitors. Exemplary additional active ingredients include 2,4-D, aminopyralid, bromacil, dicamba, diquat dibromide, flumioxazin, fosamine, glufosinate ammonium, glyphosate (glyphosate isopropylamine salt), hexazinone, imazapic, metsulfuron, picloram, propoxycarbozone, rimsulfuron, simazine, sulfometuron, and triclopyr.

In certain embodiments of the present invention, a short-residual acetohydroxyacid synthase inhibitor, such as imazamox, is the only herbicidally active ingredient. For example, the composition used in the method does not include other herbicides, fungicides, insecticides, or other agriculturally active ingredients.

In certain embodiments of the present invention, a cellulose biosynthesis inhibitor, such as indaziflam, and a short-residual acetohydroxyacid synthase inhibitor, such as imazamox, are the only herbicidally active ingredients. For example, the composition used in the method does not include other herbicides, fungicides, insecticides, or other agriculturally active ingredients.

In certain embodiments, a compositions of the present invention comprises (A) a short-residual acetohydroxyacid synthase inhibitor and (B) a cellulose biosynthesis inhibitor in a weight ratio A:B of 100:1 to 1:100, or 50:1 to 1:50, or 25:1 to 1:25, or 10:1 to 1:10.

In an aspect, a composition of the present invention comprises a short-residual acetohydroxyacid synthase inhibitor in an amount of 0.001 to 50 lb./gallon, or 0.01 to 25 lb./gallon, or 0.1 to 10 lb./gallon, or 0.5 to 5 lb./gallon.

In an aspect, a composition of the present invention comprises a short-residual acetohydroxyacid synthase inhibitor in an amount of 0.0001% to 75%, or 0.001% to 50%, or 0.01% to 33%, or 0.1% to 25% by weight of the composition.

In certain embodiments, a composition of the present invention comprises a cellulose biosynthesis inhibitor in an amount of 0.001 to 50 lb./gallon, or 0.01 to 25 lb./gallon, or 0.1 to 10 lb./gallon, or 0.5 to 5 lb./gallon.

In an aspect, a composition of the present invention comprises a cellulose biosynthesis inhibitor in an amount of 0.0001% to 75%, or 0.001% to 50%, or 0.01% to 33%, or 0.1% to 25% by weight of the composition.

In certain embodiments, a composition of the present invention may comprise at least one active ingredient in addition to a short-residual acetohydroxyacid synthase inhibitor, or in addition to both a short-residual acetohydroxyacid synthase inhibitor and a cellulose biosynthesis inhibitor, depending on the formulation. In such embodiments, said at least one additional active ingredient may be present in an amount of 0.001 to 50 lb./gallon, or 0.01 to 25 lb./gallon, or 0.1 to 10 lb./gallon.

In an aspect, compositions described herein may include any desired effective amount of one or more additional active ingredients, such as wherein said one or more additional active ingredients is/are present at a combined concentration of 0.001% to 50%, or 0.01% to 33%, or 0.1% to 25% by weight of the composition.

“Habitat” denotes where a plant or crop growing or will be grown. The method described herein can be used to treat a desirable plant or crop, or a seed, leaf, part, or habitat thereof. Alternatively, the method described herein can be applied directly to undesired vegetation to be controlled or a habitat thereof.

Compositions of the present invention may be applied to any desirable plant or crop, or a seed, leaf, part, or habitat thereof.

“Desirable plant” or “desirable vegetation” means any plant or crop that is meant to be protected from undesired vegetation.

“Undesired plant” or “undesired vegetation” means a plant or crop to be controlled, such as a weed or invasive annual grass.

In an aspect, compositions of the present invention may be applied to any desirable plant, such as ornamental or perennial grasses.

Examples of desirable ornamental or perennial grasses include, for example, Agrostis nebulosa (cloud grass), Calamagrostis x acutiflora (feather reed grass), Calamagrostis brachytricha AGM (Korean feather reed grass), Calamagrostis foliosa (coastal or leafy reedgrass), Cortaderia selloana (pampas grass), Deschampsia cespitosa (tufted hair-grass), Festuca arundinacea (tall fescue), Festuca californica (California fescue), Festuca glauca (blue fescue, grey fescue, ornamental blue fescue grass), Festuca idahoensis (Idaho fescue, blue bunchgrass), Festuca ovina (sheep's fescue), Festuca rubra (creeping fescue grass, red fescue, red fescue grass), Helictotrichon sempervirens AGM (blue oat grass), Leymus condensatus (giant wildrye, canyon prince, wild blue rye), Melica imperfecta (smallflower melic, little California melic), Miscanthus sinensis (Chinese silver grass, eulalia, eulaia grass, maiden grass, zebra grass, Susuki grass, porcupine grass), Muhlenbergia rigens (deer grass), Panicum virgatum (switchgrass), Pennisetum alopecuroides (Chinese fountain grass, Chinese pennisetum, fountain grass, swamp foxtail grass), Pennisetum setaceum AGM & P. setaceum ‘Rubrum’ AGM (red fountain grass, African fountain grass, fountain grass, purple fountain grass, ruby grass), Pennisetum villosum AGM (feathertop), Stipa gigantea AGM (golden oats), Stipa tenuissima syn. Nassella tenuissima (Mexican feather grass, Texas needle grass), Carex comans (New Zealand hair sedge), Carex elata ‘Aurea’ AGM (Bowles' golden sedge), Carex flacca (syn. C. glauca) (blue sedge, gray carex, glaucous sedge, or carnation-grass), Carex oshimensis, Carex pansa (sand dune sedge), Carex pendula (pendulous, hanging, drooping or weeping sedge), Carex praegracilis (clustered field sedge, field sedge, expressway sedge), Carex siderosticta (creeping broad-leafed sedge)—several cultivars, Carex spissa (San Diego sedge), Carex (including Japanese sedges and others), and Uncinia rubra (red hook sedge).

Compositions according to the present invention can be formulated in any desired manner and include any desired excipients.

The product used can be a commercial formulation which contains various formulation additives.

The compositions can be formulated as a granular formulation, seed treatment, foliar composition, a foliar spray, solutions, emulsions, suspension, coating formulation, encapsulated formulation, solid, liquid, fertilizer, paste, powder, suspension, or suspension concentrate. The composition may be employed alone or in solid, dispersant, or liquid formulation.

In yet another aspect, a composition described herein is formulated as a tank-mix product.

These formulations are produced in any desired or known manner, for example by mixing the active compounds with extenders, such as liquid solvents, pressurized liquefied gases and/or solid carriers, optionally with the use of surface-active agents, such as emulsifiers and/or dispersants and/or foam formers. If the extender used is water, it is also useful to employ for example organic solvents as cosolvents. Suitable liquid solvents include: aromatics, such as xylene, toluene or alkylnaphthalenes, chlorinated aromatics or chlorinated aliphatic hydrocarbons, such as chlorobenzenes, chloroethylenes or methylene chloride, aliphatic hydrocarbons, such as cyclohexane or paraffins, for example mineral oil fractions, alcohols, such as butanol or glycol as well as their ethers and esters, ketones, such as acetone, methyl ethyl ketone, methyl isobutyl ketone or cyclohexanone, strongly polar solvents, such as dimethylformamide and dimethyl sulphoxide, and also water. Liquefied gaseous extenders or carriers include those liquids which are gaseous at ambient temperature and at atmospheric pressure, for example aerosol propellants such as halogenated hydrocarbons and also butane, propane, nitrogen and carbon dioxide. As solid carriers there are suitable: for example, ground natural minerals, such as kaolins, clays, talc, chalk, quartz, attapulgite, montmorillonite or diatomaceous earth, and ground synthetic minerals, such as finely divided silica, alumina and silicates. As solid carriers for granules there are suitable: for example, crushed and fractionated natural rocks such as calcite, pumice, marble, sepiolite and dolomite, and also synthetic granules of inorganic and organic meals, and granules of organic material such as sawdust, coconut shells, maize cobs and tobacco stalks. As emulsifiers and/or foam formers there are suitable: for example, non-ionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and protein hydrolysates. As dispersants, for example, lignosulphite waste liquors and methylcellulose are suitable.

Tackifiers such as carboxymethylcellulose and natural and synthetic polymers in the form of powders, granules or latices, such as gum arabic, polyvinyl alcohol and polyvinyl acetate, as well as natural phospholipids, such as cephalins and lecithins, and synthetic phospholipids, can be used in the formulations. Other possible additives are mineral and vegetable oils.

Colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc, can also be used.

In certain embodiments, other ingredients, such as insecticides, fertilizers, biostimulants, and/or soil amendments can be used with the cellulose biosynthesis inhibitor in the methods of the invention.

Any desired plant or crop can be treated by a composition of the present invention to control undesired vegetation. In another aspect, compositions of the present invention may be applied directly to undesired vegetation to be controlled.

In an aspect, compositions comprising both an acetohydroxyacid synthase inhibitor and a cellulose biosynthesis inhibitor may be used to control any undesired vegetation, including invasive annual grasses.

In an aspect, compositions comprising an acetohydroxyacid synthase inhibitor as a sole active ingredient are particularly effective at controlling invasive annual grasses.

“Invasive annual grass”, “annual grass”, “annual weed” and “weed” are used interchangeably herein and are understood as meaning, in the present context any undesired grass or weed species.

In an aspect, methods and compositions of the present invention may be used to control any weed, including Abelmoschus esculentus, Abrus precatorius, Abutilon theophrasti, Acacia auriculiformis, Acacia confuse, Acacia mearnsii, Acacia melanoxylon, Acacia paradoxa, Acacia parramattensis, Acaena novae-zelandiae, Acaena pallida, Acalypha ostryifolia, Acalypha virginica, Acanthospermum hispidum, Acer ginnala, Acer negundo, Acer platanoides, Acer pseudoplatanus, Acer rubrum, Achillea millefolium, Achillea millefolium var. occidentalis, Achnatherum brachychaetum, Acroptilon repens, Adenanthera pavonina, Aegilops cylindrica, Aegilops geniculate, Aegilops triuncialis, Aeginetia, Aegopodium podagraria, Aeschynomene indica, Aeschynomene rudis, Aeschynomene virginica, Agave sisalana, Ageratina adenophora, Ageratina altissima var. altissima, Ageratina riparia, Agrostemma githago, Agrostis. stolonifera, Ailanthus altissima, Albizia julibrissin, Albizia lebbeck, Alectra, Alhagi maurorum, Alliaria petiolata, Allium, Allium canadense, Allium neapolitanum, Allium paniculatum, Allium textile, Allium vineale, Allium vineale ssp. compactum, Alnus glutinosa, Alopecurus carolinianus, Alopecurus myosuroides, Alstonia macrophylla, Alternanthera, Alternanthera philoxeroides, Alternanthera pungens, Alternanthera sessilis, Alyssum alyssoides, Amaranthus albus, Amaranthus blitoides, Amaranthus hybridus, Amaranthus palmeri, Amaranthus powellii, Amaranthus retroflexus, Amaranthus spinosus, Amaranthus tuberculatus, Amaranthus viridis, Ambrosia acanthicarpa, Ambrosia artemisiifolia, Ambrosia artemisiifolia var. elation, Ambrosia grayi, Ambrosia psilostachya, Ambrosia tomentosa, Ambrosia trifida, Ammannia coccinea, Ammophila arenaria, Amorpha fruticosa, Ampelopsis brevipedunculata, Amphiachyris dracunculoides, Amsinckia menziesii var. intermedia, Anagallis arvensis, Anchusa arvensis, Anchusa officinalis, Andropogon bicornis, Andropogon gerardii, Andropogon virginicus, Anemone hupehensis, Angiopteris evecta, Anoda cristata, Anredera cordifolia, Anredera vesicaria, Anthemis arvensis, Anthemis cotula, Anthriscus sylvestris, Antigonon leptopus, Apocynum androsaemifolium, Apocynum cannabinum, Arabidopsis thaliana, Araujia sericifera, Archontophoenix alexandrae, Arctium minus, Arctotheca calendula, Ardisia crenata, Ardisia elliptica, Argemone mexicana, Argemone polyanthemos, Aristida oligantha, Aristida purpurea, Aristolochia elegans, Arrhenatherum elatius var. bulbosum, Artemisia absinthium, Artemisia annua, Artemisia biennis, Artemisia campestris, Artemisia cana, Artemisia dracunculus, Artemisia filifolia, Artemisia frigida, Artemisia ludoviciana, Artemisia tridentata, Artemisia vulgaris, Arthraxon hispidus, Arthrostemma ciliatum, Arundo donax, Asclepias fascicularis, Asclepias incarnata, Asclepias labriformis, Asclepias physocarpa, Asclepias speciosa, Asclepias subverticillata, Asclepias syriaca, Asclepias verticillata, Asparagus aethiopicus, Asphodelus fistulosus, Astragalus bisulcatus, Astragalus missouriensis, Astragalus mollissimus, Asystasia gangetica, Atriplex semibaccata, Atriplex subspicata, Avena barbata, Avena fatua, Avena sativa, Avena sterilis, Axonopus fissifolius, Azolla pinnata, Bacopa rotundifolia, Barbarea orthoceras, Barbarea vulgaris, Bassia hyssopifolia, Bassia scoparia, Bauhinia variegata, Begonia cucullata, Bellardia trixago, Bellis perennis, Berberis, Berberis thunbergii, Berberis vulgaris, Berteroa incana, Bidens alba, Bidens aristosa, Bidens bipinnata, Bidens cernua, Bidens cynapiifolia, Bidens frondosa, Bidens pilosa, Bischofia javanica, Bocconia frutescens, Bouteloua dactyloides, Brachypodium distachyon, Brachypodium sylvaticum, Brassica, Brassica juncea, Brassica nigra, Brassica rapa, Brassica tournefortii, Brickellia eupatorioides var. eupatorioides, Bromus arvensis, Bromus carinatus, Bromus catharticus, Bromus diandrus, Bromus diandrus ssp. rigidus, Bromus hordeaceus, Bromus hordeaceus ssp. hordeaceus, Bromus inermis, Bromus japonicus, Bromus racemosus, Bromus rubens, Bromus secalinus, Bromus sterilis, Bromus tectorum, Broussonetia papyrifera, Bruguiera sexangula, Brunnichia ovata, Bryonia alba, Bryum argenteum, Buddleja davidii, Buglossoides arvensis, Bupleurum rotundifolium, Butomus umbellatus, Cabomba caroliniana, Caesalpinia decapetala, Calandrinia ciliata, Callirhoe involucrata, Callitriche stagnalis, Calophyllum antillanum, Calystegia sepium, Calystegia sepium ssp. sepium, Camelina microcarpa, Campanula rapunculoides, Campsis radicans, Cannabis sativa, Caperonia palustris, Capsella bursa-pastoris, Cardamine hirsuta, Cardamine impatiens, Cardamine parviflora, Cardaria chalepensis, Cardaria draba, Cardaria pubescens, Cardiospermum halicacabum, Carduus, Carduus acanthoides, Carduus crispus, Carduus nutans, Carduus pycnocephalus, Carduus tenuiflorus, Carex kobomugi, Carpobrotus edulis, Carthamus lanatus, Carthamus lanatus ssp. creticus, Carthamus leucocaulos, Carthamus oxyacanthus, Carum carvi, Castilla elastica, Casuarina, Casuarina equisetifolia, Casuarina glauca, Caulerpa taxifolia, Cecropia obtusifolia, Celastrus orbiculatus, Cenchrus echinatus, Cenchrus longispinus, Cenchrus spinifex, Centaurea calcitrapa, Centaurea cyanus, Centaurea diffusa, Centaurea iberica, Centaurea jacea, Centaurea macrocephala, Centaurea melitensis, Centaurea nigra, Centaurea nigrescens, Centaurea solstitialis, Centaurea stoebe ssp. micranthos, Centaurea sulphurea, Centaurea virgata, Centaurea virgata ssp. squarrosa, Centromadia pungens ssp. pungens, Cerastium fontanum, Cerastium fontanum ssp. vulgare, Ceratocephala testiculata, Cereus hildmannianus, Cestrum diurnum, Cestrum nocturnum, Chaenorhinum minus, Chamaecrista fasciculata var. fasciculata, Chamaesyce glyptosperma, Chamaesyce humistrata, Chamaesyce hyssopifolia, Chamaesyce maculata, Chamaesyce nutans, Chamerion angustifolium ssp. angustifolium, Chenopodium album, Chenopodium berlandieri, Chenopodium leptophyllum, Chenopodium murale, Chenopodium simplex, Chloris verticillata, Chloris virgata, Chondrilla juncea, Chorispora tenella, Chromolaena odorata, Chrysophyllum cainito, Chrysophyllum mexicanum, Chrysophyllum oliviforme, Chrysopogon aciculatus, Chrysothamnus viscidiflorus, Cichorium intybus, Cicuta douglasii, Cicuta maculata, Cinchona pubescens, Cinnamomum burmannii, Cinnamomum camphora, Cirsium, Cirsium altissimum, Cirsium arvense, Cirsium canescens, Cirsium discolor, Cirsium flodmanii, Cirsium foliosum, Cirsium horridulum, Cirsium japonicum, Cirsium ochrocentrum, Cirsium undulatum, Cirsium vulgare, Citharexylum caudatum, Citharexylum spinosum, Citrullus lanatus var. lanatus, Citrus reticulata ssp. unshiu, Claytonia perfoliata ssp. perfoliata, Clematis orientalis, Clematis terniflora, Clematis virginiana, Clematis vitalba, Cleome gynandra, Cleome serrulata, Clerodendrum bungei, Clerodendrum chinense, Clerodendrum macrostegium, Clidemia hirta, Clidemia hirta var. hirta, Clusia rosea, Cnicus benedictus, Coccinia grandis, Cocculus carolinus, Colocasia esculenta, Colubrina asiatica, Commelina benghalensis, Commelina communis, Commelina diffusa, Conicosia pugioniformis, Conium maculatum, Conoclinium coelestinum, Convallaria majalis, Convolvulus arvensis, Conyza bonariensis, Conyza canadensis, Coreopsis tinctoria, Coronopus didymus, Coronopus squamatus, Cortaderia jubata, Cortaderia selloana, Corynocarpus laevigatus, Cosmos bipinnatus, Cosmos sulphurous, Cotoneaster lacteus, Cotoneaster pannosus, Crassula helmsii, Crataegus monogyna, Crepis setosa, Crotalaria, Crotalaria spectabilis, Croton capitatus, Croton glandulosus, Croton setigerus, Croton texensis, Crupina vulgaris, Cryptostegia madagascariensis, Cucumis anguria, Cucumis melo, Cucumis myriocarpus, Cucurbita foetidissima, Cupaniopsis anacardioides, Cuscuta, Cuscuta approximata, Cuscuta boldinghii, Cuscuta cassytoides, Cuscuta epilinum, Cuscuta epithymum, Cuscuta europaea, Cuscuta indecora, Cuscuta indecora var. bifida, Cuscuta indecora var. indecora, Cuscuta indecora var. longisepala, Cuscuta indecora var. neuropetala, Cuscuta japonica, Cuscuta pentagona, Cuscuta pentagona var. glabrior, Cuscuta pentagona var. pentagona, Cuscuta pentagona var. pubescens, Cuscuta reflexa, Cuscuta suaveolens, Cuscuta umbellata, Cyathea cooperi, Cyclachaena xanthiifolia, Cymbopogon refractus, Cynanchum laeve, Cynanchum louiseae, Cynanchum rossicum, Cynanchum vincetoxicum, Cynara cardunculus, Cynodon, Cynodon dactylon, Cynoglossum officinale, Cyperus acuminatus, Cyperus compressus, Cyperus difformis, Cyperus erythrorhizos, Cyperus esculentus, Cyperus haspan, Cyperus involucratus, Cyperus iria, Cyperus odoratus, Cyperus prolifer, Cyperus rotundus, Cyperus strigosus, Cytisus scoparius, Cytisus scoparius var. andreanus, Cytisus scoparius var. scoparius, Cytisus striatus, Dactylis glomerata, Dactyloctenium aegyptium, Daphne laureola, Datura inoxia, Datura quercifolia, Datura stramonium, Daucus carota, Delairea odorata, Delphinium carolinianum ssp. virescens, Delphinium geyeri, Delphinium nuttallianum, Delphinium xoccidentale, Deparia petersenii, Descurainia pinnata, Descurainia sophia, Desmanthus illinoensis, Desmodium cajanifolium, Desmodium tortuosum, Dianthus armeria, Dichrostachys cinerea, Digitalis purpurea, Digitaria abyssinica, Digitaria bicornis, Digitaria ciliaris, Digitaria ischaemum, Digitaria sanguinalis, Digitaria velutina, Diodia teres, Diodia virginiana, Dioscorea alata, Dioscorea bulbifera, Dioscorea oppositifolia, Dipsacus fullonum, Dipsacus laciniatus, Dipsacus sativus, Dissotis rotundifolia, Distichlis spicata, Draba verna, Dracopis amplexicaulis, Drymaria arenarioides, Dysphania ambrosioides, Dyssodia papposa, Echinochloa colona, Echinochloa crus-galli, Echinocystis lobata, Echinodorus cordifolius, Echium plantagineum, Echium vulgare, Eclipta prostrata, Egeria densa, Ehrharta calycina, Ehrharta erecta, Eichhornia, Eichhornia azurea, Eichhornia crassipes, Elaeagnus angustifolia, Elaeagnus pungens, Elaeagnus umbellata, Elephantopus mollis, Eleusine indica, Ellisia nyctelea, Elodea canadensis, Elsholtzia ciliata, Elymus repens, Emex australis, Emex spinosa, Enterolobium contortisiliquum, Epilobium hirsutum, Epipremnum pinnatum, Equisetum arvense, Equisetum hyemale, Equisetum laevigatum, Equisetum telmateia, Eragrostis cilianensis, Eragrostis pilosa, Eragrostis spectabilis, Erechtites glomeratus, Erechtites minimus, Ericameria nauseosa ssp. nauseosa var. nauseosa, Erigeron annuus, Erigeron karvinskianus, Erigeron philadelphicus, Erigeron strigosus, Eriobotrya japonica, Eriochloa acuminata var. acuminata, Eriochloa contracta, Eriochloa villosa, Eriogonum annuum, Erodium cicutarium, Erysimum cheiranthoides, Erysimum repandum, Eschscholzia californica, Eucalyptus globulus, Eucalyptus robusta, Eugenia uniflora, Euonymus alatus, Euonymus fortunei, Eupatorium altissimum, Eupatorium capillifolium, Euphorbia cyathophora, Euphorbia cyparissias, Euphorbia dentata, Euphorbia esula, Euphorbia esula var. esula, Euphorbia heterophylla, Euphorbia marginata, Euphorbia myrsinites, Euphorbia oblongata, Euphorbia serrata, Euphorbia terracina, Euryops multifidus, Eutrochium fistulosum, Fagopyrum tataricum, Falcataria moluccana, Fatoua villosa, Ficus altissima, Ficus carica, Ficus microcarpa, Ficus rubiginosa, Fimbristylis quinquangularis, Flacourtia indica, Flaveria trinervia, Flueggea acidoton, Foeniculum vulgare, Fragaria virginiana, Frangula alnus, Fraxinus americana, Fraxinus pennsylvanica, Fraxinus uhdei, Froelichia floridana, Froelichia gracilis, Furcraea foetida, Galega officinalis, Galeopsis tetrahit, Galinsoga parviflora, Galinsoga quadriradiata, Galium aparine, Gamochaeta purpurea, Genista monspessulana, Geranium carolinianum, Geranium dissectum, Geranium robertianum, Glaucium corniculatum, Glechoma hederacea, Gleditsia triacanthos, Glossostigma cleistanthum, Glossostigma diandrum, Glyceria maxima, Glycine max, Glycyrrhiza lepidota, Gnaphalium palustre, Gossypium hirsutum, Grevillea banksii, Grevillea robusta, Grindelia papposa, Grindelia squarrosa, Gutierrezia sarothrae, Gypsophila paniculata, Haematoxylum campechianum, Halimodendron halodendron, Halogeton glomeratus, Harrisia martinii, Hedeoma hispida, Hedera helix, Hedera hibernica, Hedychium coronarium, Hedychiumflavescens, Hedychium gardnerianum, Helenium amarum, Helenium autumnale, Helianthus annuus, Helianthus ciliaris, Helianthus grosseserratus, Helianthus nuttallii, Helianthus petiolaris, Helianthus tuberosus, Helichrysum petiolare, Heliocarpus popayanensis, Heliopsis helianthoides, Hemerocallis fulva, Heracleum mantegazzianum, Heracleum maximum, Hesperis matronalis, Heteranthera limosa, Heteranthera reniformis, Heterocentron subtriplinervium, Heteropogon contortus, Heterotheca subaxillaris, Hibiscus syriacus, Hibiscus tiliaceus, Hibiscus trionum, Hieracium, Hieracium atratum, Hieracium aurantiacum, Hieracium caespitosum, Hieracium canadense, Hieracium xfloribundum, Hieracium laevigatum, Hieracium pilosella, Hieracium piloselloides, Hiptage benghalensis, Hoffmannseggia glauca, Holcus lanatus, Hordeum jubatum, Hordeum murinum ssp. leporinum, Hordeum pusillum, Hordeum vulgare, Humulus japonicus, Hydrilla verticillata, Hydrocharis morsus-ranae, Hygrophila polysperma, Hymenachne amplexicaulis, Hyoscyamus niger, Hyparrhenia rufa, Hypericum canadense, Hypericum perforatum, Hypochaeris radicata, Hyptis pectinata, Hyptis suaveolens, Ilex aquifolium, Impatiens glandulifera, Impatiens walleriana, Imperata brasiliensis, Imperata brevifolia, Imperata cylindrica, Ipomoea, Ipomoea alba, Ipomoea aquatica, Ipomoea carnea ssp. fistulosa, Ipomoea coccinea, Ipomoea cordatotriloba var. cordatotriloba, Ipomoea hederacea, Ipomoea lacunosa, Ipomoea pandurata, Ipomoea purpurea, Ipomoea quamoclit, Ipomoea triloba, Ipomoea turbinata, Ipomoea wrightii, Iris douglasiana, Iris missouriensis, Iris pseudacorus, Isatis tinctoria, Ischaemum rugosum, Iva annua, Iva axillaris, Jacquemontia tamnifolia, Jasminum dichotomum, Jasminum fluminense, Jasminum sambac, Juncus bufonius, Juncus effusus, Juncus planifolius, Juncus polyanthemos, Juncus tenuis, Juniperus virginiana, Kalanchoe pinnata, Kickxia elatine, Koelreuteria elegans, Kummerowia stipulacea, Kummerowia striata, Lactuca floridana, Lactuca serriola, Lactuca tatarica var. pulchella, Lagarosiphon, Lagarosiphon major, Lagascea mollis, Lamium amplexicaule, Lamium purpureum, Lamium purpureum var. incisum, Landoltia punctata, Lantana camara, Lappula occidentalis, Lapsana communis, Larrea tridentata, Lathyrus latifolius, Leonurus cardiaca, Lepidium austrinum, Lepidium campestre, Lepidium densiflorum, Lepidium latifolium, Lepidium perfoliatum, Lepidium virginicum, Leptochloa chinensis, Leptochloa fusca ssp. fascicularis, Leptochloa fusca ssp. uninervia, Leptochloa panicoides, Leptospermum scoparium, Lepyrodiclis holosteoides, Lespedeza bicolor, Lespedeza cuneata, Leucaena leucocephala, Leucanthemum vulgare, Ligustrum lucidum, Ligustrum obtusifolium, Ligustrum ovalifolium, Ligustrum sinense, Ligustrum vulgare, Limnobium spongia, Limnocharis flava, Limnophila indica, Limnophila sessiliflora, Linaria dalmatica, Linaria dalmatica ssp. dalmatica, Linaria genistifolia, Linaria vulgaris, Livistona chinensis, Lolium perenne ssp. multiflorum, Lolium temulentum, Lonicera xbella, Lonicera fragrantissima, Lonicera japonica, Lonicera maackii, Lonicera morrowii, Lonicera tatarica, Lonicera xylosteum, Lophostemon confertus, Lotus corniculatus, Ludwigia decurrens, Ludwigia grandiflora ssp. grandiflora, Ludwigia grandiflora ssp. hexapetala, Ludwigia peploides, Lunularia cruciata, Lupinus arboreus, Lupinus perennis, Lupinus plattensis, Lupinus pusillus, Lupinus wyethii, Lychnis flos-cuculi, Lycium barbarum, Lycium ferocissimum, Lycopus americanus, Lygodesmia juncea, Lygodium japonicum, Lygodium microphyllum, Lysimachia nummularia, Lysimachia vulgaris, Lythrum, Lythrum salicaria, Lythrum virgatum, Macaranga mappa, Macaranga tanarius, Macfadyena unguis-cati, Machaeranthera canescens, Machaeranthera pinnatifida ssp. pinnatifida var. pinnatifida, Macleaya cordata, Madia sativa, Mahonia, Malachra alceifolia, Malva neglecta, Malvella leprosa, Marah oreganus, Marchantia polymorpha ssp. polymorpha, Marrubium vulgare, Marsilea quadrifolia, Matricaria discoidea, Medicago lupulina, Medicago polymorpha, Medicago sativa, Medinilla cummingii, Medinilla magnifica, Medinilla venosa, Melaleuca quinquenervia, Melastoma, Melastoma candidum, Melastoma malabathricum, Melastoma sanguineum, Melia azedarach, Melilotus officinalis, Melinis minutiflora, Melinis repens, Melochia corchorifolia, Melochia umbellata, Mentha arvensis, Mentha xpiperita, Mentha pulegium, Mentha spicata, Mentzelia decapetala, Merremia tuberosa, Mesembryanthemum crystallinum, Miconia, Miconia calvescens, Microlaena stipoides, Microstegium vimineum, Mikania cordata, Mikania micrantha, Mikania scandens, Milium vernale, Mimosa diplotricha, Mimosa pellita, Mirabilis nyctaginea, Miscanthus floridulus, Miscanthus sinensis, Misopates orontium, Mollugo verticillata, Monarda fistulosa, Monarda pectinata, Monochoria hastata, Monochoria vaginalis, Monolepis nuttalliana, Montanoa hibiscifolia, Moraea, Moraea collina, Moraea flaccida, Moraea miniata, Moraea ochroleuca, Moraea pallida, Morella cerifera, Morella faya, Morus alba, Mosla dianthera, Muhlenbergia frondosa, Muhlenbergia racemosa, Muhlenbergia schreberi, Murdannia keisak, Murraya exotica, Muscari botryoides, Muscari comosum, Muscari neglectum, Myoporum laetum, Myosotis scorpioides, Myriophyllum aquaticum, Myriophyllum heterophyllum, Myriophyllum spicatum, Najas minor, Nandina domestica, Nardus stricta, Nassella trichotoma, Nasturtium microphyllum, Nasturtium officinale, Nechamandra alternifolia, Nekemias arborea, Nelumbo lutea, Neonotonia wightii var. wightii, Nepeta cataria, Nephrolepis cordifolia, Nephrolepis multiflora, Neyraudia reynaudiana, Nicandra physalodes, Nicotiana glauca, Nuttallanthus canadensis, Nymphaea mexicana, Nymphaea odorata, Nymphoides peltata, Ochrosia elliptica, Oeceoclades maculata, Oenothera biennis, Oenothera curtiflora, Oenothera laciniata, Oenothera sinuosa, Oenothera suffrutescens, Oenothera xerogaura, Olea europaea, Ononis alopecuroides, Onopordum, Onopordum acanthium, Onopordum acaulon, Onopordum illyricum, Onopordum tauricum, Opuntia aurantiaca, Opuntia fragilis, Opuntia polyacantha, Ornithogalum umbellatum, Orobanche, Orobanche cooperi, Orobanche minor, Orobanche ramosa, Oryza longistaminata, Oryza punctata, Oryza rufipogon, Oryza sativa, Ottelia alismoides, Oxalis corniculata, Oxalis stricta, Oxyspora paniculata, Oxytropis lambertii, Oxytropis sericea, Packera glabella, Paederia cruddasiana, Paederia foetida, Panicum antidotale, Panicum capillare, Panicum dichotomiflorum, Panicum miliaceum, Panicum repens, Panicum virgatum, Papaver dubium, Papaver somniferum, Paraderris elliptica, Paraserianthes lophantha ssp. montana, Parietaria pensylvanica, Parthenium hysterophorus, Parthenocissus quinquefolia, Paspalum conjugatum, Paspalum denticulatum, Paspalum dilatatum, Paspalum laeve, Paspalum notatum, Paspalum scrobiculatum, Paspalum urvillei, Passiflora bicornis, Passiflora biflora, Passiflora edulis, Passiflora foetida, Passiflora incarnata, Passiflora laurifolia, Passiflora ligularis, Passiflora lutea, Passiflora suberosa, Passiflora tarminiana, Passiflora tripartita var. mollissima, Pastinaca sativa, Paulownia tomentosa, Peganum harmala, Pennisetum ciliare, Pennisetum clandestinum, Pennisetum macrourum, Pennisetum pedicellatum, Pennisetum polystachion, Pennisetum purpureum, Pennisetum setaceum, Perilla frutescens, Phalaris aquatica, Phalaris arundinacea, Phalaris canadensis, Phalaris minor, Phleum pratense, Phoenix reclinata, Phormium tenax, Phragmites australis, Phyllanthus tenellus, Phyllanthus urinaria, Phyllostachys aurea, Phyllostachys nigra, Physalis acutifolia, Physalis angulata, Physalis heterophylla, Physalis longifolia, Physalis longifolia var. subglabrata, Physalis virginiana, Physalis viscosa, Phytolacca americana, Picris hieracioides, Pimenta dioica, Pimenta racemosa, Pinus elliottii var. elliottii, Pinus patula, Pinus pinaster, Pinus radiata, Pinus taeda, Piper aduncum, Pistia stratiotes, Pittosporum undulatum, Plantago aristata, Plantago lanceolata, Plantago major, Plantago patagonica, Plantago rugelii, Pluchea carolinensis, Pluchea indica, Poa annua, Poa bulbosa, Poa compressa, Poa pratensis, Poa trivialis, Polygonatum biflorum, Polygonum achoreum, Polygonum amphibium, Polygonum arenastrum, Polygonum aviculare, Polygonum cespitosum, Polygonum convolvulus, Polygonum cuspidatum, Polygonum erectum, Polygonum lapathifolium, Polygonum orientale, Polygonum pensylvanicum, Polygonum perfoliatum, Polygonum persicaria, Polygonum polystachyum, Polygonum ramosissimum, Polygonum sachalinense, Polypogon monspeliensis, Pontederia cordata, Pontederia rotundifolia, Populus alba, Populus deltoides, Portulaca oleracea, Potamogeton crispus, Potentilla recta, Potentilla simplex, Proboscidea louisianica, Prosopis, Prosopis alpataco, Prosopis argentina, Prosopis burkartii, Prosopis caldenia, Prosopis calingastana, Prosopis campestris, Prosopis castellanosii, Prosopis denudans, Prosopis elata, Prosopis farcta, Prosopis ferox, Prosopis fiebrigii, Prosopis glandulosa, Prosopis hassleri, Prosopis humilis, Prosopis juliflora, Prosopis kuntzei, Prosopis pallida, Prosopis palmeri, Prosopis reptans, Prosopis rojasiana, Prosopis ruizlealii, Prosopis ruscifolia, Prosopis sericantha, Prosopis strombulifera, Prosopis torquata, Prosopis velutina, Prunella vulgaris, Prunus serotina, Prunus virginiana, Psidium cattleianum, Psidium guajava, Pteridium aquilinum, Pteridium aquilinum var. pubescens, Pteris vittata, Ptychosperma elegans, Pueraria montana, Pueraria montana var. lobata, Pueraria phaseoloides, Pyrrhopappus carolinianus, Ranunculus abortivus, Ranunculus acris, Ranunculus arvensis, Ranunculus bulbosus, Ranunculus ficaria, Ranunculus repens, Ranunculus sardous, Raphanus raphanistrum, Raphanus sativus, Retama monosperma, Rhamnus, Rhamnus cathartica, Rhizophora mangle, Rhodomyrtus tomentosa, Rhus glabra, Rhus typhina, Rhynchospora caduca, Rhynchospora corniculata, Ribes, Richardia scabra, Ricinus communis, Robinia pseudoacacia, Rorippa austriaca, Rorippa palustris, Rorippa sinuata, Rorippa sylvestris, Rosa arkansana, Rosa multiflora, Rosa rugosa, Rottboellia cochinchinensis, Rubus argutus, Rubus armeniacus, Rubus ellipticus var. obcordatus, Rubus fruticosus, Rubus glaucus, Rubus laciniatus, Rubus moluccanus, Rubus niveus, Rubus phoenicolasius, Rubus rosifolius, Rubus sieboldii, Rudbeckia hirta, Ruellia caerulea, Rumex, Rumex acetosella, Rumex altissimus, Rumex crispus, Rumex obtusifolius, Saccharum spontaneum, Sacciolepis indica, Sagina procumbens, Sagittaria graminea, Sagittaria latifolia, Sagittaria montevidensis, Sagittaria sagittifolia, Salsola, Salsola collina, Salsola kali, Salsola paulsenii, Salsola tragus, Salsola vermiculata, Salvia aethiopis, Salvia lyrata, Salvia pratensis, Salvia reflexa, Salvia sclarea, Salvia xsuperba, Salvinia, Salvinia auriculata, Salvinia biloba, Salvinia herzogii, Salvinia molesta, Sansevieria hyacinthoides, Saponaria officinalis, Sarcobatus vermiculatus, Saururus cernuus, Scaevola sericea, Schedonnardus paniculatus, Schedonorus arundinaceus, Schedonorus pratensis, Schefflera actinophylla, Schinus molle, Schinus terebinthifolius, Schismus arabicus, Schismus barbatus, Schizachyrium condensatum, Schoenoplectiella mucronata, Schoenoplectus acutus var. acutus, Scleranthus annuus, Sclerochloa dura, Scolymus, Scolymus hispanicus, Scoparia dulcis, Secale cereal, Securigera varia, Senecio jacobaea, Senecio madagascariensis, Senecio riddellii, Senecio squalidus, Senecio vulgaris, Senna obtusifolia, Senna occidentalis, Senna pendula var. glabrata, Sesbania herbacea, Sesbania punicea, Setaria faberi, Setaria italica, Setaria palmifolia, Setaria parviflora, Setaria pumila, Setaria pumila ssp. pallidefusca, Setaria pumila ssp. pumila, Setaria verticillata, Setaria viridis, Sibara virginica, Sicyos angulatus, Sida rhombifolia, Sida spinosa, Silene conoidea, Silene latifolia ssp. alba, Silene noctiflora, Silene vulgaris, Silphium perfoliatum, Silybum, Silybum marianum, Sinapis, Sinapis arvensis ssp. arvensis, Sisymbrium altissimum, Sisymbrium irio, Sisymbrium loeselii, Sisymbrium officinale, Smilax rotundifolia, Solanum americanum, Solanum cardiophyllum, Solanum carolinense, Solanum dimidiatum, Solanum diphyllum, Solanum dulcamara, Solanum elaeagnifolium, Solanum jamaicense, Solanum lanceolatum, Solanum marginatum, Solanum nigrum, Solanum physalifolium, Solanum ptycanthum, Solanum robustum, Solanum rostratum, Solanum tampicense, Solanum torvum, Solanum triflorum, Solanum viarum, Solidago altissima, Solidago canadensis, Solidago missouriensis, Soliva sessilis, Sonchus arvensis, Sonchus arvensis ssp. arvensis, Sonchus arvensis ssp. uliginosus, Sonchus aspen, Sonchus oleraceus, Sorghastrum nutans, Sorghum almum, Sorghum bicolor, Sorghum halepense, Sorghum propinquum, Sparganium erectum, Spartina alterniflora, Spartina anglica, Spartina densiflora, Spartina patens, Spartium junceum, Spathodea campanulata, Spergula arvensis, Spermacoce alata, Sphaeralcea coccinea, Sphaerophysa salsula, Sphagneticola trilobata, Sphenoclea zeylanica, Spiraea japonica, Sporobolus cryptandrus, Sporobolus indicus, Sporobolus vaginiflorus, Stachys floridana, Stellaria graminea, Stellaria media, Stratiotes abides, Striga, Striga asiatica, Symphoricarpos occidentalis, Symphyotrichum divaricatum, Symphyotrichum ericoides var. ericoides, Symphyotrichum pilosum var. pilosum, Symphytum asperum, Syngonium podophyllum, Syzygium cumini, Syzygium jambos, Taeniatherum caput-medusae, Tagetes minuta, Tamarix, Tamarix aralensis, Tamarix chinensis, Tamarix gallica, Tamarix parviflora, Tamarix ramosissima, Tanacetum vulgare, Taraxacum officinale, Tectaria incisa, Terminalia catappa, Tetradymia canescens, Tetragonia tetragonioides, Tetrastigma voinieranum, Tetrazygia bicolor, Teucrium canadense, Themeda villosa, Thermopsis rhombifolia, Thespesia populnea, Thlaspi arvense, Thymelaea passerina, Thymus praecox ssp. arcticus, Tibouchina, Tibouchina herbacea, Tibouchina longifolia, Tibouchina urvilleana, Toona ciliata, Torilis arvensis, Toxicodendron pubescens, Toxicodendron radicans, Toxicodendron radicans ssp. radicans, Toxicodendron rydbergii, Toxicodendron vernix, Tradescantia fluminensis, Tradescantia spathacea, Tragopogon dubius, Trapa, Trapa natans, Trema orientalis, Triadica sebifera, Trianthema portulacastrum, Tribulus cistoides, Tribulus terrestris, Tridax procumbens, Trifolium arvense, Trifolium campestre, Trifolium incarnatum, Trifolium repens, Triglochin maritima, Triodanis perfoliata, Triphasia trifolia, Tripleurospermum perforatum, Tripsacum dactyloides, Triticum aestivum, Triumfetta rhomboidea, Triumfetta semitriloba, Tussilago farfara, Typha latifolia, Ulex europaeus, Ulmus parvifolia, Ulmus pumila, Urena lobata, Urochloa fusca, Urochloa maxima, Urochloa mutica, Urochloa panicoides, Urochloa platyphylla, Urochloa ramosa, Urochloa texana, Urtica dioica, Urtica dioica ssp. gracilis, Utricularia inflata, Vaccaria hispanica, Vachellia farnesiana, Valeriana officinalis, Valerianella radiata, Ventenata dubia, Veratrum californicum, Verbascum blattaria, Verbascum thapsus, Verbena bracteata, Verbena hastata, Verbena stricta, Verbena urticifolia, Verbesina encelioides, Vernicia fordii, Vernonia baldwinii, Vernonia gigantea, Veronica agrestis, Veronica arvensis, Veronica biloba, Veronica filiformis, Veronica peregrina, Veronica persica, Viburnum lantana, Viburnum opulus, Vicia sativa ssp. nigra, Vicia tetrasperma, Vicia villosa, Vigna unguiculata, Vinca major, Vinca minor, Viola arvensis, Viola nephrophylla, Viola sororia, Viscum album, Vitis, Vitis aestivalis, Vitis labrusca, Vitis riparia, Vitis vulpina, Vossia cuspidata, Vulpia myuros, Vulpia octoflora, Wisteria floribunda, Wisteria sinensis, Xanthium, Xanthium spinosum, Xanthium strumarium, Xanthium strumarium var. canadense, Xylorhiza glabriuscula, Yucca glauca Zea mays Zigadenus venenosus and Zygophyllum fabago.

In an aspect, methods and compositions of the present invention are used to control annual grasses belonging to the genera Bromus, Ventenata, Taeniatherum, Secale, and Aegilops.

In another aspect, methods and compositions of the present invention are used to control Bromus tectorum (cheatgrass or downy brome), Bromus rubens (red brome), Bromus secalinus (cheat) and Bromus japonicus (Japanese brome), Ventenata dubia (ventenata), Taeniatherum caput-medusae (medusahead), Secale cereal (feral rye) Aegilops triuncialis (barb goatgrass), and Aegilops cylindrica.

A composition described herein can be applied to a soil, plant or crop, or a seed, leaf, or part thereof in a single application step. In another aspect, a composition described herein is applied to a desirable plant or crop such as ornamental or perennial grass, or a seed, leaf, or part thereof in multiple application steps, for example, two, three, four, five or more application steps. In another aspect, the second, third, fourth, or fifth or more application steps may be with the same or different compositions. The methods described herein also provide for an aspect where multiple application steps are excluded.

In another aspect, a composition described herein is applied directly to unwanted vegetation, such as an invasive annual grass, or a seed, leaf, or part thereof in multiple application steps, for example, two, three, four, five or more application steps. In another aspect, the second, third, fourth, or fifth or more application steps may be with the same or different compositions. The methods described herein also provide for an aspect where multiple application steps are excluded.

A composition described herein can be applied to a soil, desirable plant or crop, or a seed, or part thereof in one or more application intervals of about 30 minutes, about 1 hour, about 2 hours, about 6 hours, about 8 hours, about 12 hours, about 1 day, about 5 days, about 7 days, about 10 days, about 12 days, about 14 days, about 21 days, about 28 days, about 35 days, about 45 days, about 50 days, or about 56 days.

A composition described herein can be applied to a desirable plant or crop such as ornamental or perennial grass, or a seed, leaf, or part thereof one or more times during a growing, planting, or harvesting season. In another aspect, a compound or composition described herein is applied to a desirable plant or crop, seed, or plant part thereof in one, two, three, four, or five or more times during a growing, planting, or harvesting season. In another aspect, a compound or composition described herein is applied to a plant, crop, seed, or plant part thereof only one time, no more than two times, or no more than three times during a growing, planting, or harvesting season. In yet another aspect, a compound or composition is applied in a single step to a seed. In yet another aspect, a seed described herein is planted in a one-pass application step.

In an aspect, a composition of the present invention is applied as a pre-plant treatment, e.g. before a desirable plant or crop is planted.

In another aspect, a composition of the present invention is applied as a post-plant treatment, e.g. after a desirable plant or crop is planted, or can be applied before and after planting.

In another aspect, the disclosure provides for pre-plant, pre-emergent, and post-emergent application steps or combinations thereof, when applying compositions of the present invention to desirable vegetation, such as ornamental or perennial grasses. In another aspect, a compound or composition described herein is first applied in a pre-plant step and followed by one or more pre-emergent or post-emergent application steps.

In another aspect, the disclosure provides for pre-emergent and post-emergent, application steps or combinations thereof, when applying compositions of the present invention directly to unwanted vegetation. In another aspect, a compound or composition described herein is first applied in a pre-emergent step, followed by one or more pre- or post-emergent application steps.

Methods described herein can be used in the treatment of genetically modified organisms (GMOs), e.g., plants or seeds. Genetically modified plants (or transgenic plants) are plants of which a heterologous gene has been stably integrated into genome. The expression “heterologous gene” essentially means a gene which is provided or assembled outside the plant and when introduced in the nuclear, chloroplastic or mitochondrial genome gives the transformed plant new or improved agronomic or other properties by expressing a protein or polypeptide of interest or by downregulating or silencing other gene(s) which are present in the plant (using for example, antisense technology, cosuppression technology or RNA interference—RNAi—technology). A heterologous gene that is located in the genome is also called a transgene. A transgene that is defined by its particular location in the plant genome is called a transformation or transgenic event.

In an aspect, plants can be obtained by traditional breeding and optimization methods or by biotechnological and recombinant methods, or combinations of these methods, including the transgenic plants and including the plant varieties which are capable or not capable of being protected by Plant Breeders' Rights.

In another aspect, plant species and plant varieties which are found in the wild or which are obtained by traditional biological breeding methods, such as hybridization or protoplast fusion, and parts of these species and varieties are treated. In a further preferred embodiment, transgenic plants and plant varieties which were obtained by recombinant methods, if appropriate in combination with traditional methods (genetically modified organisms) and their parts are treated.

“Plant parts” should be understood as meaning all above ground and subsoil parts and organs of plants, such as shoot, leaf, flower, root, leaves, needles, stalks, stems, fruiting bodies, fruits and seeds, tubers and rhizomes. Plant parts also include harvested crops, and also vegetative and generative propagation material, for example cuttings, tubers, rhizomes, slips and seeds.

Seeds, plant parts, leaves, and plants may be treated with the described compositions by applying the compounds or compositions directly to the seed, plant part, leaf, or plant. In another aspect, the seed, plant part, leaf, or plant may be treated indirectly, for example by treating the environment or habitat in which the seed, plant part, leaf, or plant is exposed to. Conventional treatment methods may be used to treat the environment or habitat including dipping, spraying, fumigating, chemigating, fogging, scattering, brushing on, shanking or injecting.

According to the invention, the treatment of plants or crops, and seeds, leaves or parts thereof with a composition described herein can be carried out directly by the customary treatment methods, for example by immersion, spraying, vaporizing, fogging, injecting, dripping, drenching, broadcasting or painting, and seed treatment.

A compound or composition described herein can take any of a variety of dosage forms including, without limitation, suspension concentrates, aerosols, capsule suspensions, cold-fogging concentrates, warm-fogging concentrates, encapsulated granules, fine granules, flowable concentrates for the treatment of seed, ready-to-use solutions, dustable powders, emulsifiable concentrates, oil-in-water emulsions, water-in-oil emulsions, macrogranules, microgranules, oil-dispersible powders, oil-miscible flowable concentrates, oil-miscible liquids, foams, pastes, pesticide-coated seed, suspoemulsion concentrates, soluble concentrates, wettable powders, soluble powders, dusts and granules, water-soluble granules or tablets, water-soluble powders for the treatment of seed, wettable powders, natural products and synthetic substances impregnated with a compound or composition described herein, a net impregnated with a compound or composition described herein, and also microencapsulations in polymeric substances and in coating materials for seed, and also ULV cold-fogging and warm-fogging formulations.

A composition disclosed herein may optionally include one or more additional compounds providing an additional beneficial or otherwise useful effect. Such compounds include, without limitation, an adhesive, a surfactant, a solvent, a wetting agent, an emulsifying agent, a carrier, an adjuvant, a diluent, a dispersing agent an insecticide, a pesticide, a fungicide, a fertilizer of a micronutrient or macronutrient nature, a herbicide, a feeding inhibitor, an insect molting inhibitor, an insect mating inhibitor, an insect maturation inhibitor, a nematacide, a nutritional or horticultural supplement, or any combination thereof. In an aspect, a composition described herein is odor free.

Compositions described herein can be combined with a fertilizer. Examples of fertilizers capable of being used with the compositions and methods described herein include, for example, urea, ammonium nitrate, ammonium sulfate, calcium nitrate, diammonium phosphate, monoammonium phosphate, triple super phosphate, potassium nitrate, potassium nitrate, nitrate of potash, potassium chloride, muriate of potash, di- and mono-potassium salts of phosphite/phosphonate.

As demonstrated in the below Examples, it has been found by the inventors that both superior post-emergence control and long-term, residual control of annual grasses can be achieved by applying compositions of the present invention to desirable plants, seeds, parts, and/or habitats thereof, or by applying compositions of the present invention directly to a site in which undesired annual grasses are growing.

The following examples serve to illustrate certain aspects of the disclosure and are not intended to limit the disclosure.

### EXAMPLES

In the following Examples, desirable perennial grasses were treated to control the invasive annual grass Bromus tectorum (cheatgrass) either pre-emergence or post-emergence with either indaziflam, imazapic, imazamox, glyphosate, or combinations thereof. Imazapic, glyphosate, and combinations comprising either imazapic and/or glyphosate were used for purposes of comparison.

### Example 1—Herbicidal Compositions Used

Table 2 summarizes the herbicidal compositions used to test the efficacies of imazamox, indaziflam, and combinations thereof.

TABLE 2
Herbicidal Compositions used

| Active Ingredient | Formulation | Concentration |
|---|---|---|
| Indaziflam (Esplanade ® 200SC) | suspension | 1.67 lb ae/gallon |
| | concentrate | |
| Imazapic (Plateau ®) | ammonium salt | 2 lb ae/gallon |
| Imazamox (Raptor ®) | ammonium salt | 1 lb ae/gallon |
| Glyphosate (Accord ® XRT II) | dimethylamine | 4 lb ae/gallon |
| | salt | |

### Example 2—Post-Emergence Data

Table 3 summarizes the herbicidal efficacies (% Control), damage caused to desired perennial grasses (% Injury), and cover (% Cover) when the active ingredients of Table 1 were applied to perennial grasses of species Bromus inermis (smooth brome) and Agropyron smithii (western wheatgrass).

TABLE 3
Post-Emergence Data

| | Year 1 | | Year 2 | | |
|---|---|---|---|---|---|
| | % Control | % Injury | % Control | % Injury | % Cover |
| | Bromus | Perennial | Bromus | Perennial | Perennial |
| | tectorum | grasses | tectorum | grasses | grasses |
| Control: Untreated | 0 | 0 | 0 | 0 | 42 |
| Control: Imazapic | 97 | 15 | 77 | 1 | 72 |
| (Plateau ® applied | | | | | |
| at 7 oz/A) | | | | | |
| Control: | 37 | 0 | 93 | 0 | 72 |
| Indaziflam | | | | | |
| (Esplanade ® | | | | | |
| 200SC applied at 7 oz/ | | | | | |
| A) | | | | | |
| Invention: | 98 | 0 | 20 | 0 | 63 |
| Imazamox | | | | | |
| (Raptor ® applied | | | | | |
| at 6 oz/A) | | | | | |
| Invention: | 100 | 5 | 98 | 0 | 83 |
| Indaziflam | | | | | |
| (Esplanade ® | | | | | |
| 200SC applied at 7 oz/ | | | | | |
| A) + | | | | | |
| Imazamox | | | | | |
| (Raptor ® applied | | | | | |
| at 6 oz/A) | | | | | |

All treatments include 0.25% NIS.

Imazapic, indaziflam, imazamox, and a combination of indaziflam and imazamox were applied via a backpack research sprayer to perennial grasses to control Bromus tectorum post-emergence.

Imazapic was included as an operational standard. Control from Imazapic dropped from 97% in the first year after treatment to 77% in the second year after treatment.

The control from imazamox by itself dropped from 98% in the first year after treatment to 20% in the second year after treatment, thus indicating short residual control by imazamox at rates that were selective on perennial grass.

Control from indaziflam by itself increased from 37% in the first year after treatment to 93% in the second year after treatment, thus indicating that indaziflam missed Bromus tectorum that had germinated at the time of application. Rather, the long period of residual control helped provide pre-emergence control for the second year after treatment.

Control from the combination of indaziflam and imazamox according to the present invention was notably 100% for the first year after treatment and 98% for the second year after treatment, thus indicating that the imazamox component helped to provide post-emergence control during the first year after treatment, whereas the indaziflam component provided continuing control the second year after treatment.

Perennial grass injury for the combination of indaziflam and imazamox was less than the injury attributable to imazapic, the operational standard (5% compared to 15% for the first year after treatment). Thus, imazamox can be used in combination with indaziflam at rates that are selective on perennial grass.

Perennial grass responded positively to the increased control of Bromus tectorum (cheatgrass) provided by the combination of indaziflam and imazamox. Perennial grass cover in the second year after treatment was 83% for the combination of indaziflam and imazamox, compared to 72% for imazapic and 42% for the untreated check.

### Example 3—Pre-Emergence Data

Table 3 summarizes the herbicidal efficacies (% Control) and damage caused to desired perennial grasses (% Injury) during the first year after the active ingredients of Table 1 were applied to perennial grasses of species Hesperostipa comata (needle-and-thread), Aristida purpurea (purple three-awn) and Bouteloua gracilis (blue grama). Table 4 further sets forth the biomass in kilograms per hectare (kg/ha) of Bromus tectorum and perennial grass measured in the first year after treatment.

TABLE 4
Pre-Emergence Data

| | | | Biomass | Biomass |
|---|---|---|---|---|
| | % Control | % Injury | (kg/ha) | (kg/ha) |
| | Bromus | Perennial | Bromus | Perennial |
| | tectorum | grasses | tectorum | grasses |
| Control: Untreated | 0 | 0 | 171 | 50 |
| Control: Imazapic | 90 | 10 | 7 | 91 |
| (Plateau ® applied at | | | | |
| 7 oz/A) | | | | |
| Control: Indaziflam | 72 | 10 | 83 | 54 |
| (Esplanade ® 200SC | | | | |
| applied at 3.5 oz/A) | | | | |
| Control: Indaziflam | 82 | 0 | 18 | 63 |
| (Esplanade ® 200SC | | | | |
| applied at 5 oz/A) | | | | |
| Control: Indaziflam | 80 | 5 | 32 | 75 |
| (Esplanade ® 200SC | | | | |
| applied at 7 oz/A) | | | | |
| Invention: Indaziflam | 96 | 5 | 1 | 113 |
| (Esplanade ® 200SC | | | | |
| applied at 7 oz/A) + | | | | |
| Imazamox (Raptor ® | | | | |
| applied at 6 oz/A) | | | | |

All treatments include 0.25% NIS.

Imazapic, indaziflam, and a combination of indaziflam and imazamox were applied via a backpack research sprayer to desirable perennial grasses to control unwanted Bromus tectorum pre-emergence.

The control of invasive Bromus tectorum for the combination of indaziflam and imazamox was 96% compared to 72-82% for indaziflam alone. Perennial grass biomass was 113 kg/ha for the combination of indaziflam and imazamox, compared to 54-75 kg/ha for indaziflam alone. Thus, imazamox, when applied in combination with indaziflam, helped to provide control of early germinating Bromus tectorum.

The control of unwanted Bromus tectorum for the combination of indaziflam and imazamox according to the present invention was 96% compared to 90% for imazapic, the operational standard. Total biomass of Bromus tectorum for Esplanade+Raptor was 1 kg/ha comparted to 7 kg/ha for imazapic and 171 kg/ha for the untreated check.

Perennial grass injury attributable to the combination of indaziflam and imazamox was less than that of imazapic, the operational standard (5% compared to 10%), thus indicating that imazamox can be used in combination with indaziflam at rates that are selective on perennial grass.

Perennial grass responded positively to the increased control of unwanted Bromus tectorum provided by the combination of indaziflam and imazamox according to the present invention. Perennial grass one growing season after treatment was 113 kg/ha for the combination of indaziflam and imazamox, compared to 91 kg/ha for imazapic and 50 kg/ha for the untreated check.

### Example 4—Post-Emergence Data

Table 4 summarizes the herbicidal efficacies (% Control) and damage caused to desired perennial grasses (% Injury) during the first year after the active ingredients of Table 1 were applied to perennial grasses of species Hesperostipa comata (needle-and-thread), Aristida purpurea (purple three-awn) and Bouteloua gracilis (blue grama). Table 5 further sets forth the biomass in kilograms per hectare (kg/ha) of unwanted Bromus tectorum and perennial grass measured in the first year after treatment.

TABLE 5
Post-Emergence Data

| | | | Biomass | Biomass |
|---|---|---|---|---|
| | % Control | % Injury | (Kg/Ha) | (Kg/Ha) |
| | Bromus | Perennial | Bromus | Perennial |
| | tectorum | grasses | tectorum | grasses |
| Control: Untreated | 0 | 0 | 287 | 52 |
| Control: Imazapic (Plateau ® | 100 | 18.8 | 0 | 142 |
| applied at 7 oz/A) + | | | | |
| Glyphosate (Accord ® XRT II | | | | |
| applied at 10 oz/A) | | | | |
| Control: Indaziflam (Esplanade ® | 69 | 2.5 | 108 | 100 |
| applied at 3.5 oz/A) + | | | | |
| Glyphosate (Accord ® XRT II | | | | |
| applied at 10 oz/A) | | | | |
| Control: Indaziflam (Esplanade ® | 69 | 2.5 | 85 | 88 |
| applied at 5 oz/A) + | | | | |
| Glyphosate (Accord ® XRT II | | | | |
| applied at 10 oz/A) | | | | |
| Control: Indaziflam (Esplanade ® | 80 | 8.8 | 66 | 146 |
| applied at 7 oz/A) + | | | | |
| Glyphosate (Accord ® XRT II | | | | |
| applied at 10 oz/A) | | | | |
| Invention: Indaziflam | 79 | 15 | 25 | 194 |
| (Esplanade ® applied at 7 oz/A) + | | | | |
| Imazamox (Raptor ® applied at | | | | |
| 6 oz/A) | | | | |

All treatments include 0.25% NIS.

A combination of imazapic and glyphosate, various combinations of indaziflam and glyphosate, and a combination of indaziflam and imazamox according to the invention were applied via a backpack research sprayer to perennial grasses to control unwanted Bromus tectorum post-emergence. Combinations comprising imazapic and/or glyphosate were used for comparison against the combination of indaziflam and imazamox of the present invention.

Imazapic was applied in a tank mix with glyphosate since post-emergence control from imazapic in the spring is generally poor. Similarly, glyphosate was added to indaziflam to provide post-emergence control.

Control of unwanted Bromus tectorum for a combination of indaziflam and imazamox was 79% compared to 69-80% for a combination of indaziflam and glyphosate and 100% for a combination of imazapic and glyphosate.

However, perennial grass injury was greatest for the combination of imazapic and glyphosate at 18.8%. Although perennial grass injury was also relatively high for the combination of indaziflam and imazamox, perennial grass biomass responded positively.

Perennial grass biomass was 194 kg/ha for the combination of indaziflam and imazamox, compared to 142 kg/ha for the combination of imazapic and glyphosate, 88-146 kg/ha for the combination of indaziflam and glyphosate, and 52 kg/ha for the untreated check. These results indicate that imazamox can be used in combination with indaziflam at rates that are selective on perennial grass.

Application of combinations according to the present invention comprising both indaziflam and imazamox resulted in the greatest biomass for desirable perennial grass (194 kg/ha). Accordingly, compositions of the present invention surprisingly exhibited significantly less harsh effects on desirable vegetation to be protected.

1. A method for controlling undesired vegetation in rangeland comprising applying to a desirable plant or crop in rangeland or directly to the rangeland in which one or more undesired annual grasses are growing a composition comprising (A) at least one short-residual imidazolinone herbicide having a median soil half-life of no greater than 50 days.

2. The method according to claim 1, wherein the (A) at least one short-residual imidazolinone having a median soil half-life of no greater than 50 days is imazamox.

3. The method according to claim 1, wherein said composition further comprises (B) at least one cellulose biosynthesis inhibitor.

4. The method according to claim 3, wherein the (B) at least one cellulose biosynthesis inhibitor is indaziflam.

5. The method according to claim 3, wherein the (A) at least one short-residual imidazolinone having a median soil half-life of no greater than 50 days is imazamox and the (B) at least one cellulose biosynthesis inhibitor is indaziflam

6. The method according to claim 3, wherein the (A) at least one short-residual acetohydroxyacid synthase inhibitor is applied at a rate of between 0.001 to 150 oz/A.

7. The method according to claim 3, wherein the (B) at least one cellulose biosynthesis inhibitor is applied at a rate of between 0.001 oz/A to 150 oz/A.

8. The method according to claim 3, wherein the (A) at least one short-residual acetohydroxyacid synthase inhibitor is applied at a rate of between 0.001 to 150 oz/A, and the (B) at least one cellulose biosynthesis inhibitor is applied at a rate of between between 0.001 oz/A to 150 oz/A.

9. The method according to claim 1, wherein the undesired vegetation is an invasive annual grass.

10. A composition comprising (A) at least one short-residual acetohydroxyacid synthase inhibitor having a median soil half-life of no greater than 50 days; and (B) at least one cellulose biosynthesis inhibitor.

11. The composition according to claim 10, wherein the (A) at least one short-residual acetohydroxyacid synthase inhibitor having a median soil half-life of no greater than 50 days is an imidazolinone.

12. The composition according to claim 10, wherein the (A) at least one short-residual acetohydroxyacid synthase inhibitor having a median soil half-life of no greater than 50 days is imazamox.

13. The composition according to claim 10, wherein the (B) at least one cellulose biosynthesis inhibitor is indaziflam.

14. The composition according to claim 10, wherein the (A) at least one short-residual acetohydroxyacid synthase inhibitor having a median soil half-life of no greater than 50 days is imazamox and the (B) at least one cellulose biosynthesis inhibitor is indaziflam

15. The composition according to claim 14, wherein imazamox and indaziflam are the only herbicidally active ingredients.

16. The composition according to claim 10, wherein the (A) at least one short-residual acetohydroxyacid synthase inhibitor having a median soil half-life of no greater than 50 days and the (B) at least one cellulose biosynthesis inhibitor are present in a weight ratio A:B of 100:1 to 1:100.

17. The composition according to claim 10, wherein the (A) at least one short-residual acetohydroxyacid synthase inhibitor having a median soil half-life of no greater than 50 days and the (B) at least one cellulose biosynthesis inhibitor are present in a weight ratio A:B of 50:1 to 1:50.

18. The composition according to claim 10, wherein the (A) at least one short-residual acetohydroxyacid synthase inhibitor having a median soil half-life of no greater than 50 days and the (B) at least one cellulose biosynthesis inhibitor are present in a weight ratio A:B of 25:1 to 1:25.

19. A method for controlling undesirable vegetation comprising applying to undesirable vegetation or a habitat thereof the composition according to claim 8.

20. The method according to claim 19, wherein the undesirable vegetation is an invasive annual grass in rangeland.
